(19) United States
(12) Patent Application Publication
(10) Pub. No.: US 2021/0248704 A1
(43) Pub. Date: Aug. 12, 2021

(54) System and Method for Creating School Bus Routes Based on Student Assignments

(71) Applicant: Jason Wang, Latham, NY (US)

(72) Inventor: Jason Wang, Latham, NY (US)

(21) Appl. No.: 17/172,992

(22) Filed: Feb. 10, 2021

Related U.S. Application Data
(60) Provisional application No. 62/975,618, filed on Feb. 12, 2020.

(51) Int. Cl. G06Q 50/26; G07C 5/00; G06Q 10/10; G01C 21/34

(52) U.S. Cl. CPC G06Q 50/265; G01C 21/343; G06Q 10/10; G07C 5/008

(57) ABSTRACT

A system and method for creating and accurately updating school bus routes based on commuter assignments in real-time are disclosed. The system comprises a server including a processor and a memory that stores a set of instructions executable by the processor. A computing device is positioned inside a vehicle, for example, a school bus to identify the commuters, for example, school students boarding the vehicle by reading a unique code printed on their ID cards using a built-in camera, stop locations of the vehicle, and pickup and drop off times. The server could receive information related to the commuters, stop locations, and pickup and drop off times from the computing device via a network and identify the sequence of stop locations, thereby generating a route based on the commuter assignment. The server could update the routes based on the updated information and commuter assignments after the initial route is generated.

### BACKGROUND OF THE INVENTION

In many countries including the United States, school buses are used to ferry students to and from school. This involves the transportation of children to and from school generally by means of a network of school buses and routes, relaying children from different pick-up locations to one or more assigned school drop-off locations. Typically, school buses travel along set routes, passing from house to house or from bus stop to bus stop, stopping to pick up or discharge students at designated times. School buses are the safest mode of student transportation. Millions of school children take a ride to and from school on buses every day, which are operated by school district transportation departments. Today's school transportation systems do not always work as fast and as reliably as is reasonably expected. Frequently we hear about multiple problems with the school buses. This may equally pertain to bus routes, bus stops locations and times, student to bus stop assignments in the morning and in the evening, and/or to any transportation changes.

School bus drivers today must undergo extensive training to drive safely, as well as to monitor and protect the students onboard. Currently, bus drivers use written directions to follow the bus route, which creates an unsafe condition for the students. The bus driver must divide his attention based on traffic conditions, and written instructions take the driver's attention away from the road and reduce the driver's ability to drive the bus, thus increasing the likelihood of possible unwanted consequences. Furthermore, the bus driver may not stop the school bus at safe locations/stops to pick-up and drop the students.

Further, since student transportation began, school districts have been challenged with the problem of not knowing which students are on which buses, and bus drivers have struggled with keeping track of their riders and remembering which riders are to embark/disembark at each stop. Schools and transportation departments can receive phone calls several times a week from distraught parents worried about the status of their children, or from parents requesting different transportation arrangements for their children. Sometimes, one or more buses may not be able to service their designated route, due to a mechanical failure, medical emergency, harsh weather or traffic. In such cases, it is difficult for dispatchers to reassign transportation resources quickly to assure an efficient transportation service for all students.

Student transportation involves a lot of moving parts and can be a source of a district's greatest risk exposure. Each year there are numerous reports of students getting on the wrong bus, getting off at the wrong bus stop or failing to return home from field trips. In addition, typically, school buses travel along set routes, passing from house to house or from bus stop to bus stop, stopping to pick up or discharge students at designated times. However, school buses do not always arrive at the pre-designated stops on time, as a result of traffic conditions, weather, or the like. In the winter season especially, and/or when raining, children sometimes have to suffer harsh weather conditions for a half hour or longer while waiting for the school bus at a school bus stop. Longer waiting periods increase the probability of traffic accidents, as well as the potential for interaction with unwelcome strangers.

At the present time most school districts rely on the bus driver to identify the students boarding the bus by visual recognition and/or by name recognition. The bus driver may or may not have a check off a list of the names of all the students scheduled for his bus for the bus route. It is a fully manual system and there is no accurate way for the school transportation or district administration to determine real-time what students are on-board the bus or what students have disembarked from the bus. Although some school districts have the bus driver report into the appropriate school district department by radio or cell phone when a student is absent from assigned bus transportation. There is no current system that presently exists, except the system of the present invention that accurately identifies each student that has boarded a school bus or disembarked from a school bus. Also, any system that requires much additional action by the driver in the boarding and deboarding process may meet with strong resistance to implementation and can slow buses that must operate on strict route schedules.

Another reoccurring problem with school bus transportation is substitute drivers not being familiar with an assigned daily route. Over time the substitute drivers learn the school bus routes, but before they master the routes, they must rely on hardcopy maps or typed instructions furnished by the school district transportation department.

These transportation systems are still, in many instances, managed using paper and/or phone/fax-based communication means to manage the plurality of bus routes and coordination between drivers and dispatchers. These methods are highly inefficient and result in higher costs, higher fuel usage and late arrivals, for example. Traditional methods used for creating school bus routes involve a manual process, including using maps and pens. The routes are created and maintained manually by the school district transportation department personnel. The school buses' current schedules may be manually updated and may only be available as a printed hard copy. Currently, the process for creating and updating school bus routes is complicated and time consuming, resulting in the majority of the school districts not having accurate school bus routes. This inaccuracy problem has not been solved before now.

It would be tremendously valuable to have access to the real-time location of any school bus in a school district bus fleet and also the real-time specific identity of all students riding each school bus. Besides providing a high level of security, such access monitoring prevents or minimizes the chance of students becoming lost by boarding or exiting a school bus at the wrong assigned stop location. Knowing what bus, a student is being transported on and the location of the bus in real-time, is particularly advantageous in the event of a student with a medical emergency. It is vital for security and other reasons described above to furnish a method and system that can enable school district transportation administrators to have real-time information for the location of each of its school buses and the identity of all students on the bus real-time during all types of daily school transportation. Such tracking systems range from mobile applications that track the location of mobile computing devices, for example, smart phones or other tracking devices of the students to more advanced systems that also track the location of school buses transporting the students to and from school, the location of the students while at school, and provide image data depicting the students at the schools or on the school buses.

Currently, there are a number of emerging technologies available in the market today to make school buses safer, including video cameras on both the inside and outside of the bus, stop-arm cameras, student and vehicle tracking technology, lane departure warnings, and collision mitigation systems. Many school buses across the country have seat belts, either two-point lap belts and more recently, three-point lap/shoulder belts.

Even though the use of computer software is ubiquitous in schools, more than 50 percent of the school transportation department still rely upon manual processes combined with simple software tools such as Microsoft Word or Excel to manage the creation and maintenance of school bus routes. Moreover, the risk associated with transporting school students to and from school is immense. Therefore, having a school bus route planner is an added advantage, especially for ensuring students' safety.

The major contributing factors for this technology include the following: the tools used to manage school bus operations, maps, scheduling and routing software. Due to the relatively small size of the market sector, innovations in this industry are relatively limited compared with other sectors. Computer skills for the users in school transportation (drivers, routers, and transportation supervisors) are relatively limited compared with other parts of schools. The work environment for school bus drivers is more stressful than other professions, as students who are riding the buses are in unsupervised settings compared with them in schools (supervised by teachers and administrators) and home (supervised by parents or family members). Further, the information flow and data collection in school transportation systems are not well coordinated and the software platforms for promoting collaboration do not exist in the school transportation software industry. Therefore, data does not currently flow well.

The majority of the school bus routing software tools that are available in the market were designed over a quarter-century ago and have not changed with the rapid development of software technology. The rigid architecture of these routing software's place many restrictions on users, making it very difficult for them to learn and acquire needed proficiency to create and maintain high-quality school bus routes. This older technology is unable to change or adapt and does not use relational databases. Even though attempts have been made to adapt these products to be used online and in mobile settings, the core of these products remains desktop oriented. This means the process prevalent today, inter alia, does not take full advantage of the web and mobile technology.

The first phase of the approach is to utilize a clickable GPS device on the school bus. The driver or a driver's assistant on the bus will click the GPS device to indicate a stop and record and/or send the latitude and longitude of the stop to the back-end server. The problem with this approach is that users never have a visual guide on the route. Frequently, multiple clicks or no clicks are recorded on a stop. This results in errors and inaccuracies. In addition, student's assignments are not recorded at all.

The second phase involves mobile applications usually installed on a smartphone. In this configuration, the drivers or assistant driver on the bus will press a button with an App to record the location of the school bus stop. The latitudes and longitudes are recorded and send to the backend server. This approach is very similar to the clickable GPS except that the routes are visually displayed on the smartphone for the user to see without recording the student's assignments. Typically, student tracking systems use global navigation satellite systems (GNSS) such as the global positioning system (GPS). GNSS receivers of the mobile computing devices or tracking devices receive positioning signals from GNSS satellites, which are then used to generate location information for the students or buses. The student tracking systems then use the location information to determine if the students boarded the buses and whether they arrived at school.

These approaches have been helpful in creating the routes, but the process is still very complicated and time-consuming. They require the active participation of drivers, via their smartphones, who are usually too busy and occupied with managing the students on board while driving the school bus. Lack of student's assignments for each stop is a missing piece and updating the routes is not fully addressed.

School bus routes are simply a sequence of stops with assigned students for pickup and drop-off at corresponding locations. However, creating accurate school bus routes is very time consuming and difficult. As a result, the majority of school districts do not have accurate school bus routes, potentially exposing the school districts to unknown risks that may result in injuries to students. Furthermore, the existing methods and computer tools are too complicated, and time consuming for typical school transportation systems to create and maintain accurate school bus routes. Such systems do not always work as fast and as reliably as they should and are expected to and are inaccurate.

Therefore, there is a clear and present need for a system and method for accurately and efficiently creating and updating the school bus routes with the student's assignments in real-time. Further, there is also a need for a system and method for maintaining accurate school bus routes to provide more safety for the school students and assist the driver by recording stops on a device without being distracted.

### SUMMARY OF THE INVENTION

The present invention generally relates to a transportation route creating method and system and more particularly relates to a system and method for efficiently creating school bus routes and accurately updating the routes based on student assignments in real-time to provide more safety for the students and provide an exhilarating ride for the driver.

In one embodiment, the system includes a database and a server. In one embodiment, the server including at least one processor and a memory in communication with the at least one processor, wherein the memory stores a set of instructions executable by the processor. In one embodiment, the database is in communication with the server.

In one embodiment, a computing device is securely and operatively positioned in a vehicle, for example, a school bus. The computing device is configured to identify one or more commuters, for example, school students, boarding the vehicle by reading a unique code printed on their identification (ID) cards using a built-in camera, stop locations include longitude and latitude coordinates of the vehicle, and pickup and drop off times. In one embodiment, the unique code is at least any one of, but not limited to, a two-dimensional graphical code, a barcode, and a quick response (QR) code that is printed on their ID card issued to the commuters, for example, school students. In one embodiment, the computing device is further configured to store and transfer the information related to the commuters, such as name, pickup and drop off times, and the stop locations of the vehicle.

In one embodiment, the computing device could access the server of the system via a network. In one embodiment, the computing device is at least any one of, but not limited to, a smartphone, a tablet, a personal digital assistant (PDA), a notebook, and a portable computing device. In one embodiment, the network is at least any one of, but not limited to, Wi-Fi, a cellular network, a wireless local area network (WLAN), and a radio communication. In one embodiment, the computing device is further configured to wirelessly transfer the information related to the commuters, for example, school students, the stop locations of the vehicle, and pickup and drop off times to the server of the system via the network.

In one embodiment, the system is configured to efficiently create school bus routes in real-time based on commuter assignments and received information related to the commuters boarding the vehicle, stop locations of the vehicle based on their assignments, and pickup and drop off times from the computing device. In one embodiment, the stop locations of the vehicle include longitude and latitude coordinates. The system provides more safety for the students and assists the driver in his driving without being distracted, thus providing an exhilarated ride for the driver. In one embodiment, a software application could be installed on the computing device, which is securely positioned, but not limited to, inside the vehicle. In one embodiment, the computing device is configured to constantly update the locations of the vehicle, for example, a school bus and transfer to the servers in a data center via the network. In one embodiment, the vehicle could be, but not limited to, a school bus and a school van.

In one embodiment, the server is configured to perform various steps for creating routes for the vehicle. The server could receive and store information related to the commuters, the stop locations of the vehicle, and pickup and drop off times in real-time from the computing device. In one embodiment, the database is configured to securely store the information related to the one or more commuters, the stop locations of the vehicle, and pickup and drop off times. In one embodiment, the data related to the commuters, stop locations of the vehicle, and pickup and drop off times is collected in real-time and accomplished transparently without driver intervention.

In one embodiment, the server is further configured to identify the sequence of the stop locations of the vehicle based on the commuter assignments and generate a route for the vehicle using the received information related to the commuters, the stop locations of the vehicle based on the commuter assignments, and pickup and drop off times/events from the computing device. The recorded location information allows the server to accurately place the stop locations of the vehicle on a map instead of guessing by the router or driver based on the commuter assignments. In one embodiment, the system is further configured to update the generated route of the vehicle in real-time by the server based on updated commuter assignments and information related to the one or more commuters, the stop locations of the vehicle, and pickup and drop off times received from the computing device after the initial route is generated.

In one embodiment, a method for creating and updating the vehicle's routes using the system is disclosed. The method includes various steps for creating and updating the vehicle's routes based on the commuter assignments. At one step, the computing device could identify one or more commuters, for example, school students, by reading a unique code printed on their identification (ID) cards using a built-in camera while boarding the vehicle and stop locations of the vehicle for picking up and dropping off the one or more commuters. At another step, the computing device stores and transfer the information related to the commuters, the stop locations of the vehicle, and pickup and drop off times to the server of the system in real-time via the network. At another step, the server could identify the sequence of stop locations include latitude and longitude coordinates of the vehicle based on the commuter assignments.

At another step, the server of the system could generate a route for the vehicle using the received information related to the commuters, the stop locations of the vehicle, and pickup and drop off times based on the commuter assignments. Further, at another step, the server could update the generated route in real-time based on updated commuter assignments and information related to the commuters, the stop locations of the vehicle, and the pickup and drop off times received after the initial route is generated.

One aspect of the present disclosure is directed to a system for creating a route for a vehicle based on commuter assignments, comprising: (a) a server including at least one processor and a memory in communication with the at least one processor, wherein the memory stores a set of instructions executable by the processor; (b) database in communication with the server; and (c) a computing device securely and operatively positioned inside the vehicle, wherein the computing device is configured to identify one or more commuters boarding the vehicle by reading an unique code printed on their identification (ID) cards using a built-in camera, stop locations including longitude and latitude coordinates at where the vehicle stops to pick up or drop off the one or more commuters based on their assignments, and pickup and drop off times and store information related to the boarded commuters, the stop locations of the vehicle, and pickup and drop off times, wherein the computing device accesses the server via a network for transmitting the stored information related to the one or more commuters, the stop locations of the vehicle for picking up and dropping off the one or more commuters, and pickup and drop off times, wherein the server is configured to perform the steps of: (i) receiving and storing information related to the one or more commuters, the stop locations of the vehicle, and pickup and drop off times in real-time; (ii) identifying the sequence of stop locations of the vehicle based on the commuter assignments, and (iii) generating a route of the vehicle based on the received information related to the one or more commuters, the stop locations of the vehicle, and pickup and drop off times and the commuter assignments.

Another aspect of the present disclosure is a method for creating a route for a vehicle based on commuter assignments using a system including a server having at least one processor and a memory in communication with the at least one processor, wherein the memory stores a set of instructions executable by the processor, and a database in communication with the server, wherein the method comprising the steps of: (a) identify one or more commuters by reading a unique code printed on their identification (ID) cards using a built-in camera of a computing device while boarding the vehicle, stop locations of the vehicle for picking up and dropping off the one or more commuters, and pickup and drop off times by the computing device; (b) storing and transferring the information related to the one or more commuters, the stop locations of the vehicle, and pickup and drop off times from the computing device to the server in real-time; (c) identifying the sequence of stop locations of the vehicle based on commuter assignments by the server; and (d) generating a route for the vehicle by the server using the received information related to the one or more commuters, the stop locations of the vehicle, and pickup and drop off times and based on the commuter assignments.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 illustrates a block diagram of an environment includes a transport management system and a computing device positioned inside a vehicle according to an embodiment of the present invention;

FIG. 2 shows a flowchart of a method for creating and updating a route for a vehicle, for example, a school bus using the transport management system according to one embodiment of the present invention;

FIG. 3 shows a screenshot of a rout map created by the transport management system according to one embodiment of the present invention.

FIG. 4 shows a screenshot of a map discloses detailed information related to a stop assigned to a commuter, for example, a student, vehicle details, and trip stop details according to one embodiment of the present invention.

FIG. 5 shows a screenshot illustrates a Live Track of the vehicle, for example, a school bus with a planned route on a map according to one embodiment of the present invention.

FIG. 6 shows a screenshot of recorded details of the pick up and drop off locations along the planned route on a map according to one embodiment of the present invention.

FIG. 7 shows a screenshot of a recorded pick up and drop off information of a particular commuter, for example, a student on a map according to one embodiment of the present invention.

### DETAILED DESCRIPTION

The present invention generally relates to a transportation route creating method and system and more particularly relates to a system and method for efficiently creating school bus routes and accurately updating the route based on student assignments in real-time to provide more safety for the students and provides an exhilarating ride for the driver.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

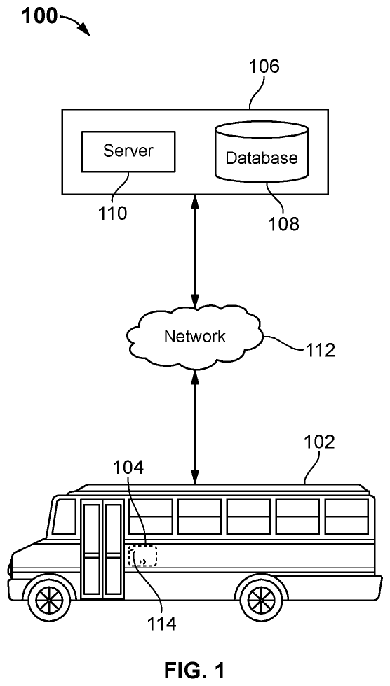

Referring to FIG. 1, a block diagram of an environment 100 implemented in accordance with an embodiment of the present invention is disclosed. In one embodiment, the environment 100 includes a computing device 104 and a transport management system 106. In one embodiment, the system 106 includes a database 108 and a server 110. In one embodiment, the server 110 including at least one processor and a memory in communication with the at least one processor, wherein the memory stores a set of instructions executable by the processor. In one embodiment, the database 108 is in communication with the server 110.

In one embodiment, the computing device 104 is securely and operatively positioned in a vehicle 102, for example, a school bus. The computing device 104 is configured to identify one or more commuters, for example, school students, boarding the vehicle 102 by reading a unique code printed on their identification (ID)cards using a built-in camera 114, stop locations include longitude and latitude coordinates of the vehicle 102, and pickup and drop off times. All commuters, for example, school students could display their ID cards near the camera 114 of the computing device 104 for scanning to identify and obtain details of the commuters boarding on the vehicle 102. In one embodiment, the unique code is at least any one of, but not limited to, a two-dimensional graphical code, a barcode, and a quick response (QR) code that is printed on their ID cards issued to the commuters, for example, school students. In one embodiment, the computing device 104 is further configured to store and transfer the information related to the commuters, such as name, pickup and drop off times, and the stop locations of the vehicle 102.

In another embodiment, the unique code could be, but not limited to, a QR code. The QR code is used for identifying the commuters, for example, school students. In one embodiment, the QR code could simply print on a plain paper using a regular printer or display the QR code via a mobile application on a smartphone. This eliminates the costly process for creating the ID cards, particularly, radio-frequency identification (RFID) cards for the commuters, for example, school students.

In one embodiment, the computing device 104 could access the server 110 of the system 106 via a network 112. In one embodiment, the computing device 104 is at least any one of, but not limited to, a smartphone, a tablet, a personal digital assistant (PDA), a notebook, and a portable computing device. In one embodiment, the network 112 is at least any one of, but not limited to, Wi-Fi, a cellular network, a wireless local area network (WLAN), and a radio communication. In one embodiment, the computing device 104 is further configured to wirelessly transfer the information related to the commuters, for example, school students, the stop locations of the vehicle 102, and pickup and drop off times to the server 110 of the system 106 via the network 112.

In one embodiment, the system 106 is configured to efficiently create school bus routes in real-time based on commuter assignments and received information related to the commuters boarding the vehicle, stop locations of the vehicle 102 based on their assignments, and pickup and drop off times from the computing device 104. In one embodiment, the stop locations of the vehicle 102 include longitude and latitude coordinates. The system 106 provides more safety for the students and assists the driver in his driving without being distracted, thus providing an exhilarated ride for the driver. In one embodiment, a software application could be installed on the computing device 104, which is securely positioned, but not limited to, inside the vehicle 102. In one embodiment, the computing device 104 is configured to constantly update the locations of the vehicle 102, for example, a school bus and transfer to the servers 110 in a data center via the network 112.

In one embodiment, the server 110 is further configured to perform various steps for creating routes for the vehicle 102. The server 110 could receive and store information related to the commuters, the stop locations of the vehicle 102, and pickup and drop off times in real-time from the computing device 104. In one embodiment, the database 108 is configured to securely store the information related to the one or more commuters, the stop locations of the vehicle, and pickup and drop off times. In one embodiment, the data related to the commuters, stop locations of the vehicle 102, and pickup and drop off times is collected in real-time and accomplished transparently without driver intervention. In one embodiment, key data collection event includes recording pickup and drop off times, stop locations, and assignment of students to the stops, is triggered by scanning the unique code, for example, a QR code, which is printed on their ID cards. In one embodiment, the server 110 is further configured to identify the sequence of the stop locations of the vehicle 102 based on the commuter assignments and generate a route for the vehicle 102 using the received information related to the commuters, the stop locations of the vehicle 102 based on the commuter assignments, and pickup and drop off times/events from the computing device 104.

The recorded location information allows the server 110 to accurately place the stop locations of the vehicle 102 on a map instead of guessing by the router or driver based on the commuter assignments. In one embodiment, the system 106 is further configured to update the generated route of the vehicle 102 in real-time by the server 110 based on updated commuter assignments and information related to the one or more commuters, the stop locations of the vehicle, and pickup and drop off times received from the computing device after the initial route is generated.

In one embodiment, the computing device 104 could continuously record the information related to the commuters, stop locations of the vehicle 102, and pickup and drop off times/events. Whenever the collected information is different from the previous trip then the information/data is provided to the router for review and update the school bus routes. In this way, the school bus routes are kept up to date using the real-time data collected during the trip of the vehicle 102, for example, a school bus.

In one embodiment, if the location of the scan event is new then the computing device 104 could identify new commuters boarding the vehicle 102, stop locations of the vehicle 102, and their pickup and drop off times. The computing device 104 further transfers that information to the server 110 via the network 112. Further, the server 110 of the system 106 generates and updates the initial generated route for the vehicle 102 based on the updated information and commuter assignments and will record the commuters, for example, school students who boards or deboard the vehicle 102 as part of the daily attendance. In one embodiment, the vehicle 102 could be, but not limited to, a school bus and a school van.

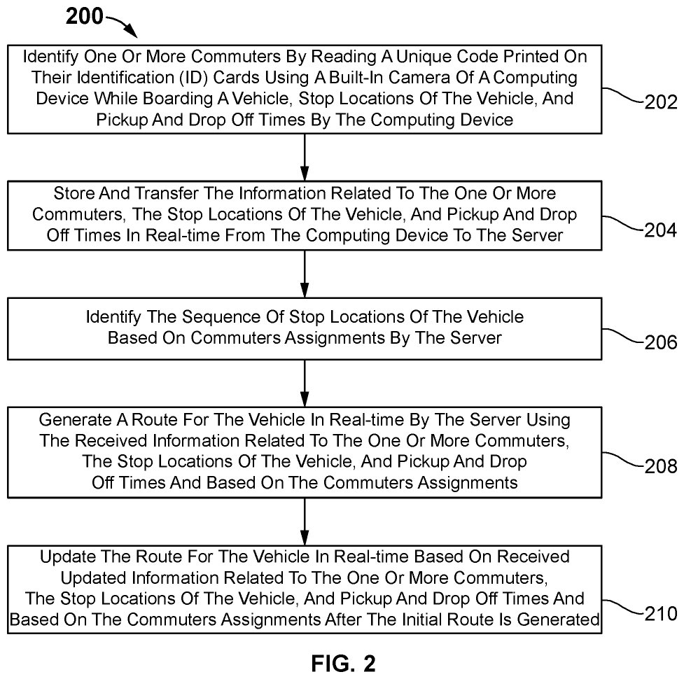

Referring to FIG. 2, a method 200 for creating and updating the vehicle's routes using the system 106 (shown in FIG. 1) is disclosed. The method 200 includes various steps for creating and updating the vehicle's routes based on the commuter assignments. At step 202, the computing device 104 (shown in FIG. 1) could identify one or more commuters, for example, school students, by reading a unique code printed on their identification (ID) cards using a built-in camera while boarding the vehicle 102 (shown in FIG. 1) and stop locations of the vehicle 102 for picking up and dropping off the one or more commuters. At step 204, the computing device 104 stores and transfer the information related to the commuters, the stop locations of the vehicle, and pickup and drop off times to the server 110 (shown in FIG. 1) of the system 106 in real-time via the network 112 (shown in FIG. 1). At step 206, the server 110 could identify the sequence of stop locations include latitude and longitude coordinates of the vehicle 102 based on the commuter assignments.

At step 208, the server 110 of the system 106 could generate a route for the vehicle 102 using the received information related to the commuters, the stop locations of the vehicle 102, and pickup and drop off times based on the commuter assignments. Further, at step 210, the server 110 could update the generated route in real-time based on updated commuter assignments and information related to the commuters, the stop locations of the vehicle 102, and the pickup and drop off times received after the initial route is generated.

The advantages of the present invention include: the system 106 could require minimum equipment to print a unique code on the ID cards using a regular printer. This eliminates the cost of producing, distributing, replacing the ID cards which could account for more than 50% of the costs compared with RFID based student ID cards. The system 106 could eliminate the need for a specialized scanner for scanning the unique code on the ID cards, thus saving the space, extra power source, and simplifying the installation on the school bus.

The entire system has fewer opportunities for hardware failures. The system 106 could assist the driver in his driving and provides an exhilarating ride for the driver. The system 106 provides comprehensive services that encompassing all major functionalities needed to safely operate the vehicle 102, for example, a school bus. These functions include, but not limited to, building school bus routes, tracking the school bus by parents, students, and school administrators, tracking student boarding and deboarding, and voice-based navigation.

In one embodiment, the server is further configured to update the route for the vehicle in real-time based on received updated information related to the one or more commuters, the stop locations of the vehicle, and pickup and drop off times and based on the commuter assignments after the initial route is generated. In one embodiment, the system is implemented using a software service application. In one embodiment, the unique code is at least any one of a two-dimensional graphical code, a barcode, and a quick response (QR) code that is printed on the ID card issued to the commuters. In one embodiment, the computing device is at least any one of a smartphone, a tablet, a personal digital assistant (PDA), a notebook, and a portable computing device. In another embodiment, the network is at least any one of Wi-Fi, a cellular network, a wireless local area network (WLAN),and a radio communication. In one embodiment, the database is configured to securely store the information related to the one or more commuters, the stop locations of the vehicle, and pickup and drop off times. In one embodiment, the vehicle is at least any one of a school bus and a school van.

In one embodiment, the method further comprises the step of updating the route for the vehicle in real-time based on received updated information related to the one or more commuters, the stop locations of the vehicle, and pickup and drop off times and based on the commuter assignments after the initial route is generated. In another embodiment, server is further configured to update the generated route of the vehicle in real-time based on received updated information related to the one or more commuters, the stop locations of the vehicle, and pickup and drop off times after the initial route is generated. In one embodiment, the computing device is configured to securely and operatively position inside the vehicle.

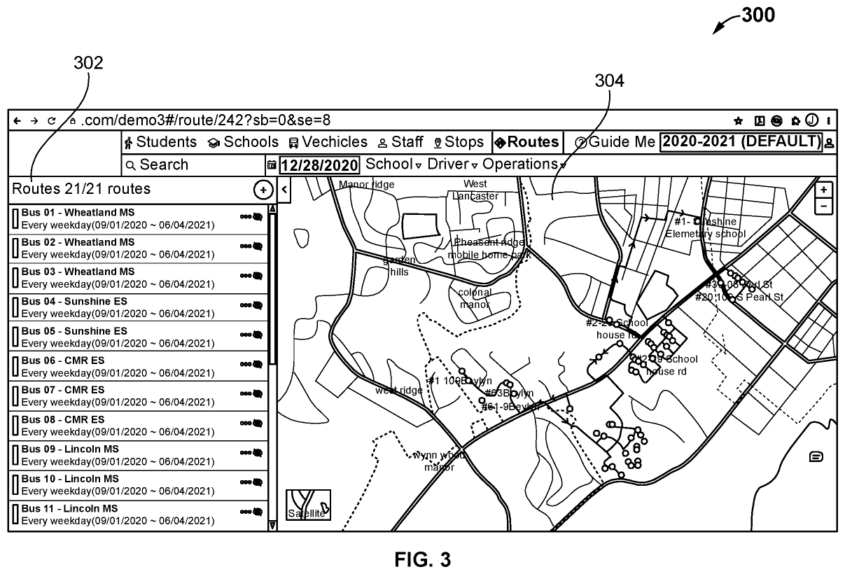

Referring to FIG. 3, a screenshot 300 of a rout map 304 created by the transport management system 106 according to one embodiment of the present invention is disclosed. In one embodiment, the route map 304 could be created using different routes 302, wherein the routes 302 are identified on the route map 304 by the server 110 using the stop locations of the vehicle 102. In one embodiment, the server 110 could perform various steps for creating routes 302 for the vehicle 102. The server 110 could also receive and store information related to the commuters, the stop locations of the vehicle 102, and pickup and drop off times in real-time from the computing device 104 for creating the route map 304.

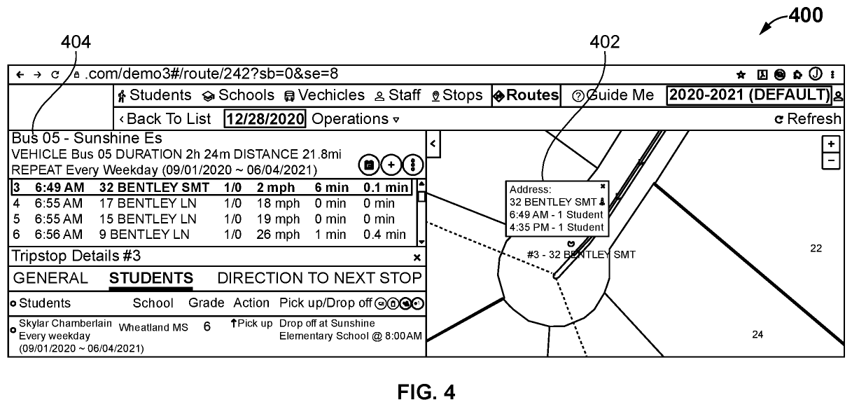

Referring to FIG. 4, a screenshot 400 of a map 402 discloses detailed information related to a stop assigned to a commuter, for example, a student, vehicle details 404, and tripstop details 406 in one embodiment is disclosed. In one embodiment, the system 106 is configured to efficiently create school bus routes in real-time based on commuter assignments and received information related to the commuters boarding the vehicle, stop locations of the vehicle 102 based on their assignments, and pickup and drop off times from the computing device 104. In one embodiment, the vehicle details 404 include, but not limited to, vehicle serial number, duration of travel, distance, stop locations, pickup and drop off times, and etc. In one embodiment, the tripstop details 406 include, but not limited to, name of the commuter, for example, a student, school name, grade, action (pick up/drop off), and location of pick up/drop off with respect to time, etc.

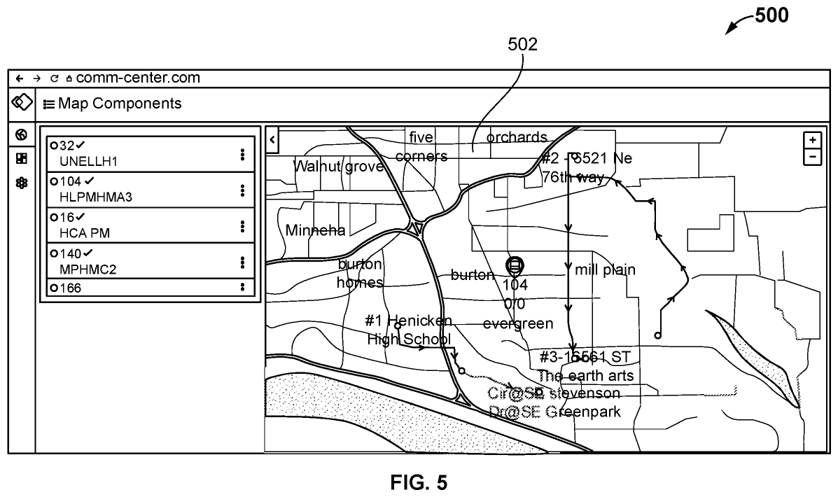

Referring to FIG. 5, a screenshot 500 illustrates a Live Track of the vehicle, for example, a school bus with a planned route on a map 502 in one embodiment is disclosed. In one embodiment, the system 106 is configured to enable for tracking the vehicle, for example, a school bus which is allotted to the commuters, for example, students for picking up and dropping off at different locations on the map 502.

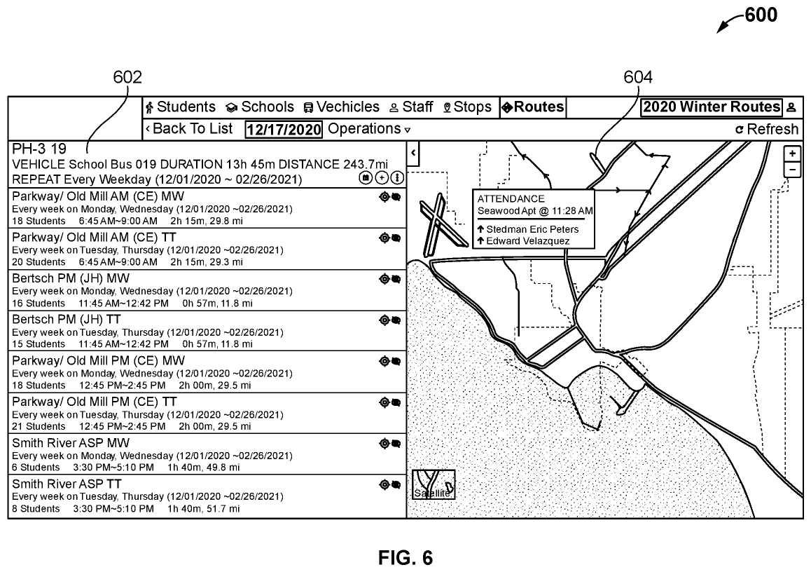

Referring to FIG. 6, a screenshot 600 of a recorded details 602 of the pick up and drop off locations along the planned route on a map 604 in one embodiment is disclosed. In one embodiment, the system 106 is configured to record the travel information, stop locations of the vehicle 102, and pickup and drop off times/events using the computing device 104. In one embodiment, the recorded details 602 include, but not limited to, vehicle serial number, travel duration, distance, pick up and drop off locations of the commuters, for example, students, etc.

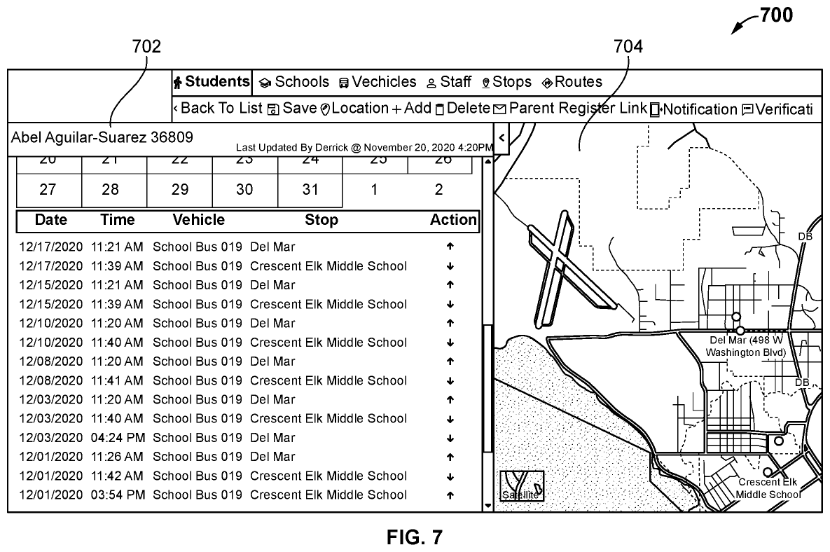

Referring to FIG. 7, a screenshot 700 of a recorded pick up and drop off information 702 of a particular commuter, for example, a student on a map 704 in an exemplary embodiment is disclosed. In one embodiment, the system 106 is configured to enable a user to track the commuter, for example, a student and check the recorded pick up and drop off information 702 of the particular commuter, for example, a student. In one embodiment, the recorded pick up and drop off information 702 includes, but not limited to, name of the commuter, for example, a student, number, date, time, vehicle number, for example, bus, stop locations, and pick up and drop off action.

The system will, in one example, transfer to the server the data accumulated from routes taken by buses over the previous weeks or months or just recent history. This data will be stored on the server. This will provide a picture of a normalized bus route or what the average bus route should look like. This collected data will then be used to predict information about future bus routes. In other words, this historical data will be used to check the current operations of buses on their routes, as against the predicted planned routes of the buses from the accumulated historical data. The purpose of doing this is to see if there are deviations from the already established planned route, such as, a bus arriving late at a stop location or not arriving at all at a stop location or students not being picked up by the bus. This will provide an alert to the managers of the school transportation department, that problems are occurring either in real time or through acquired wayward driving practices of the drivers over time. The accumulated experience of driving a route is retained for the benefit of future drivers and school transportation managers.

One application of these alerts as to deviation from average school bus routes, will be to bring to the attention of the managers of the school transportation department, any possible problems occurring in real time. For instance, a bus may have mechanical trouble or be in an accident or be stuck in traffic. In such a case, a substitute bus can be sent out to complete the bus route in normal time or the system operators can request the bus driver to go back to collect school children not picked up at a stop location.

Another application is the long-term assessment of how the bus route is being driven. By continuing to record information on a bus route over time, comparisons can be made with the accumulated average historical data (either from a driver or the route) to help improve the efficiency of driving the route. For example, taking just one data point, there can be a comparison of the current time taken to complete a route with the average, historical time taken to complete that route.

Yet another application of the comparison of historical data with current route data, can be to provide safety training for a driver, such as where deviations from the time taken, geographical route followed or the collecting and dropping off of passengers, could lead to unsafe driving practices by a driver. In other words, drivers may get into bad driving habits and by comparing current data with historical data, the drivers can be retrained to return to safe driving habits.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions.

Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A system for creating a route for a vehicle based on commuter assignments, comprising:
a server including at least one processor and a memory in communication with the at least one processor, wherein the memory stores a set of instructions executable by the processor;
a database in communication with the server, and
a computing device securely and operatively positioned inside the vehicle, wherein the computing device is configured to identify one or more commuters boarding the vehicle by reading an unique code printed on their identification (ID)cards using a built-in camera, stop locations including longitude and latitude coordinates at where the vehicle stops to pick up or drop off the one or more commuters based on their assignments, and pickup and drop off times and store information related to the boarded commuters, the stop locations of the vehicle, and pickup and drop off times,
wherein the computing device accesses the server via a network for transmitting the stored information related to the one or more commuters, the stop locations of the vehicle for picking up and dropping off the one or more commuters, and pickup and drop off times, wherein the server is configured to perform the steps of:
receiving and storing information related to the one or more commuters, the stop locations of the vehicle, and pickup and drop off times in real-time;
identifying the sequence of stop locations of the vehicle based on the commuter assignments, and
generating a route of the vehicle based on the received information related to the one or more commuters, the stop locations of the vehicle, and pickup and drop off times and the commuter assignments.

2. The system of claim 1, wherein the server is further configured to update the route for the vehicle in real-time based on received updated information related to the one or more commuters, the stop locations of the vehicle, and pickup and drop off times and based on the commuter assignments after the initial route is generated.

3. The system of claim 1, is implemented using a software service application.

4. The system of claim 1, wherein the unique code is at least any one of a two-dimensional graphical code, a barcode, and a quick response (QR) code that is printed on the ID card issued to the commuters.

5. The system of claim 1, wherein the computing device is at least any one of a smartphone, a tablet, a personal digital assistant (PDA),a notebook, and a portable computing device.

6. The system of claim 1, wherein the network is at least any one of Wi-Fi, a cellular network, a wireless local area network(WLAN),and a radio communication.

7. The system of claim 1, wherein the database is configured to securely store the information related to the one or more commuters, the stop locations of the vehicle, and pickup and drop off times.

8. The system of claim 1, wherein the vehicle is at least any one of a school bus and a school van.

9. A method for creating a route for a vehicle based on commuter assignments using a system including a server having at least one processor and a memory in communication with the at least one processor, wherein the memory stores a set of instructions executable by the processor, and a database in communication with the server, wherein the method comprising the steps of:
identify one or more commuters by reading a unique code printed on their identification (ID) cards using a built-in camera of a computing device while boarding the vehicle, stop locations of the vehicle for picking up and dropping off the one or more commuters, and pickup and drop off times by the computing device;
storing and transferring the information related to the one or more commuters, the stop locations of the vehicle, and pickup and drop off times from the computing device to the server in real-time;
identifying the sequence of stop locations of the vehicle based on commuter assignments by the server;
generating a route for the vehicle by the server using the received information related to the one or more commuters, the stop locations of the vehicle, and pickup and drop off times and based on the commuter assignments.

10. The method of claim 9, further comprising a step of: updating the route for the vehicle in real-time based on received updated information related to the one or more commuters, the stop locations of the vehicle, and pickup and drop off times and based on the commuter assignments after the initial route is generated.

11. The method of claim 9, wherein the server is further configured to update the generated route of the vehicle in real-time based on received updated information related to the one or more commuters, the stop locations of the vehicle, and pickup and drop off times after the initial route is generated.

12. The method of claim 9, wherein the computing device is configured to securely and operatively position inside the vehicle.

13. The method of claim 9, is implemented using a software service application.

14. The method of claim 9, wherein the unique code is at least any one of a two-dimensional graphical code, a barcode, and a quick response (QR) code that is printed on the ID card issued to the commuters.

15. The method of claim 9, wherein the computing device is at least any one of a smartphone, a tablet, a personal digital assistant (PDA),a notebook, and a portable computing device.

16. The method of claim 9, wherein the network is at least any one of Wi-Fi, a cellular network, a wireless local area network (WLAN),and a radio communication.

17. The method of claim 9, wherein the database is configured to securely store the information related to the one or more commuters, the stop locations of the vehicle, and pickup and drop off times.

18. The method of claim 9, wherein the vehicle is at least any one of a school bus and a school van.
